(19) United States
(12) Patent Application Publication
(10) Pub. No.: US 2024/0117157 A1
(43) Pub. Date: Apr. 11, 2024

(54) FLAME RETARDANT POLYAMIDE COMPOSITIONS WITH IMPROVED GLOW WIRE PERFORMANCE

(71) Applicant: Ascend Performance Materials Operations LLC, Houston, TX (US)

(72) Inventors: Hervé G. Cartier, Houston, TX (US); Alexis Chopin, Houston, TX (US); Olivier A. Piernot, Houston, TX (US)

(73) Assignee: Ascend Performance Materials Operations LLC, Houston, TX (US)

(21) Appl. No.: 18/480,764

(22) Filed: Oct. 4, 2023

Related U.S. Application Data
(60) Provisional application No. 63/413,499, filed on Oct. 5, 2022.

(51) Int. Cl. C08K 13/04; C08L 77/06; H01R 13/533

(52) U.S. Cl. CPC C08K 13/04; C08L 77/06; H01R 13/533; C08K 7/14; C08L 2201/02; C08L 2205/025; C08L 2205/03

(57) ABSTRACT

A flame retardant polyamide composition comprising a polyamide, a non-halogenated, phosphinate-based flame retardant, an impact modifier comprising an alkene/acrylate copolymer/terpolymer, a flame retardant synergist and an optional reinforcing agent. The flame retardant polyamide composition demonstrates a passing value for a glow wire end product test as measured by IEC 60695-2-11, a passing value for a glow wire ignition test as measured by IEC-60695-2-13:201; a passing value (V0 rating) for UL94 performance at 0.8 mm; and an elongation at break greater than 2.7%, as measured by to ISO Test No. 527:2012.

### CROSS-REFERENCE TO RELATED APPLICATION

This application claims priority from U.S. Provisional Application No. 63/413,499 entitled “Flame Retardant Polyamide Compositions With Improved Glow Wire Performance” filed Oct. 5, 2022, the disclosure of which in incorporated herein by reference in its entirety.

### FIELD

The present disclosure relates to non-halogenated flame retardant polyamide compositions. In particular, the present disclosure relates to polyamide compositions comprising a non-halogenated (halogen-free) flame retardant and an impact modifier that exhibit excellent ductility, glow wire end product, and flammability performance.

### BACKGROUND

Polymer compositions generally are known, and many have been available commercially for a long time. Conventional polymer compositions are often formed, e.g., molded, into a wide range of products.

One subset of this range of products is electrical connectors, which are commonly used in household and industrial appliances to provide a connection between the product and an electrical circuit, or between different components within the product itself. These electrical connectors often have complex geometry and are small in size. Many of these connectors have snap-fit structures, which provide for easy and fast assembly (versus nails or screws). Due to the nature and purpose of the snap-fit structures, good ductility performance is required to prevent breakage during the push operation.

Also, because electrical connectors are often required to run continuously in demanding environments under extreme temperatures and voltages, they must pass stringent safety standards to ensure consumer safety. The International Electrotechnical Commission (“IEC”) has adopted the ignition resistance in several electrical safety standards to assess the safety of electrical end-products. This comes to integrate the existing requirements of resistance to heat and fire for polyamide compositions and other resins used in components for appliances, when they are used as an insulating material. Applicable ignition and combustion resistance rests are described in the “glow wire” standards, e.g., Glow Wire End Product Test (“GWEPT”) according to IEC 60695-2-11 and Glow Wire Ignition Test (“GWIT”) according to IEC 60695-2-13.

Conventional polyamide compositions are known to have beneficial physical properties such as high melting points, high recrystallization temperatures, faster injection molding cycle times, high flow, toughness, elasticity, chemical resistance, inherent UL94 V2 flame retardancy, and abrasion resistance. However, when these polyamide compositions are exposed to high temperatures for a prolonged period, such as in automotive applications or in electrical/electronic applications, the mechanical properties generally tend to decrease due to the thermos-oxidation of the polymer, e.g., heat aging. These polyamide compositions, especially those reinforced with glass fibers, generally sacrifice an acceptable degree of inherent ignition resistance for CTI and mechanical performance. Additionally, while the addition of heat stabilizers to the polyamide compositions may improve glow wire ignition and flammability requirements, these additional components may also add other unwanted compounds/elements that detrimentally affect other parameters. In some cases, stabilizers may act as fuel, which is highly undesirable. In many cases, additives that are employed to benefit one performance characteristic typically have a detrimental effect on other performance characteristics.

Therefore, even in view of the known compositions, the need exists for polyamide compositions that can satisfy the IEC glow wire standards without the need for halogen-based flame retardants, while also demonstrating other performance features, e.g., mechanical properties, processability, or electrical properties.

### SUMMARY

In some cases, the disclosure relates to a flame retardant polyamide composition comprising (from 5 wt % to 85 wt % of) a polyamide, preferably PA-6, PA-66, PA-6,6/6I, PA-6/6T, or PA-6,6/6T, or mixtures thereof; (from 0.01 wt % to 24 wt % of) a non-halogenated flame retardant, phosphinate-based flame retardant, preferably being diethylphosphinate aluminum salt (DEPAL); at least one of: (from 1 wt % to 10 wt % of) an impact modifier comprising an alkene/acrylate copolymer/terpolymer, optionally comprising a random terpolymer of units of ethylene, methyl acrylate, and glycidyl methacrylate; and (from 0.1 wt % to 5 wt % of) a flame retardant synergist, optionally a melamine-based synergist, preferably melamine polyphosphate, and optional (less than 50 wt % of) reinforcing agent reinforcing agent, preferably being reinforced glass fibers having an average diameter greater than 10 microns; wherein the flame retardant polyamide composition demonstrates a passing value for a glow wire end product test as measured by IEC 60695-2-11, a passing value for a glow wire ignition test as measured by IEC-60695-2-13:2010, a passing value (V0 rating) for UL94 performance at 0.8 mm, and an elongation at break greater 2.7%. The composition may further demonstrate a comparative tracking index greater than 550 volts as measured by IEC 60112:2003 and/or a tensile modulus greater than 3500 MPa and/or a tensile strength of greater than 60 MPa. The composition may further comprise an additive, preferably comprising stabilizers, colorants, lubricants, antioxidants, or light stabilizers or combinations thereof. The disclosure also relates to a molded product, e.g., an electrical connector, comprising the flame retardant polyamide composition.

### DETAILED DESCRIPTION

### Introduction

As noted above, some conventional polymer, e.g., polyamide, formulations utilize heat stabilizers and flame retardants to ensure compliance with electrical safety standards. It has been found that these conventional formulations commonly sacrifice mechanical properties, processability, or electrical properties in order to comply with electrical safety standards. And heat aging performance is often insufficient for more demanding applications involving exposure to higher temperatures, e.g., automotive applications and electrical/electronic applications. In an attempt to satisfy the glow wire standards while maintaining other performance features, it has been the conventional practice to add heat stabilizers to the compositions. But when heat stabilizers are added to improve heat aging, this addition often provides for deleterious effects on other performance features, e.g., processability, ability to retard flames, or electrical properties. In many cases, additives that are employed to benefit one performance characteristic typically have a detrimental effect on other performance characteristics, e.g., gains in heat age performance lead to losses in processability. Importantly, in order to have a good snap-fit capability, the flame retarded polyamide composition needs to demonstrate both good ductility (as quantified by elongation at break, e.g., non-breakage of the lever); and also low rigidity properties (as quantified by mechanical modulus) and easy push/insertion.

Conventionally, impact modifiers are known to be detrimental to flame and ignition properties. It is sometimes postulated that because of the compositional chemistry, most can generate burning drips and act as fuel, which is a deleterious effect. Further, (higher) reinforcing agent content is often thought to improve flame retardance, at least in part due to the fact that most reinforcing agents are not non-flammable. In practice the reinforcing agents are believed to form an intumescent network, which contributes to flame retardant performance. Conventionally speaking, higher amounts of reinforcing agents lead to better flame retardant performance. In fact, many flame retardant additives are designed and marketed to work with higher reinforcing agent loading, e.g., greater than 25 wt %, greater than 30 wt %, greater than 35 wt %, greater than 40 wt %, greater than 45 wt %, greater than 50 wt %, greater than 60 wt %, or greater than 70 wt %.

The inventors have now found that a synergistic combination of particular non-halogenated flame retardants, (lower amounts of) reinforcing agents, and specific impact modifiers (optionally in the disclosed amounts) can satisfy the IEC glow wire standards without the need for halogen-based flame retardants, while maintaining other performance features, e.g., mechanical properties (elongation at break and mechanical modulus), processability, or electrical properties. It has been discovered that the disclosed compositions surprisingly improve flame retardance and ignition properties. Further, the disclosed (smaller amounts of) reinforcing agent, e.g., glass fiber, unexpectedly provide for sufficient formation of the intumescent network necessary to promote the mechanism of non-halogenated flame retardants. The use of the disclosed impact modifier, flame retardant, and/or (low) glass fiber content combination advantageously creates a synergistic combination of previously-not-achieved performance features, e.g., GWEPT performance, ductility, and mechanical performance. In particular, the disclosed polyamide compositions demonstrate superior flame retardancy, improvements to mechanical and electrical (“CTI”) performance, and reliably meet the requirements of IEC's Glow Wire Ignition Test (“GWIT”) according to IEC 60695-2-13 and Glow Wire End Product Test (“GWEPT”) according to IEC 60695-2-11. Unlike conventional flame retardant polyamide compositions, the disclosed composition does not sacrifice mechanical properties, processability, or electrical properties in order to comply with electrical safety standards. Without being bound by theory, it is believed that one reason for this is that the disclosed impact modifier contains epoxy functionality, which are believed to have a tendency to self-react (with heat), which in turn leads to a crosslinked structure that is less combustible and that does not promote burning drip during flammability testing.

The disclosed flame retardant polyamide compositions comprise a combination of impact modifier, (low) reinforcing agent content, and non-halogenated phosphinate-based flame retardant (and optional melamine flame retardant synergists). In particular, the flame retardant polyamide compositions comprise a polyamide; the impact modifier, which comprises an alkene/acrylate copolymer/terpolymer; the non-halogenated phosphinate-based flame retardant; a flame retardant synergist; and an optional reinforcing agent. These components will be discussed individually below.

### Impact Modifier

The polyamide compositions disclosed herein includes one or more impact modifiers. The inventors have found that these impact modifiers work synergistically with (and optionally do not detrimentally affect) the other components. The impact modifiers, in some cases, may be an elastomeric or rubbery material selected to have good interaction and compatibility with, and dispersion among, the one or more polyamides of the composition—again while working synergistically with the flame retardant (and optionally the synergist) and not adversely affecting other performance properties.

As noted above, the impact modifier in some embodiments comprises an alkene/acrylate copolymer/terpolymer backbone. In some cases, the impact modifier comprises a copolymer or terpolymer that has alkene and/or acrylate units. For example, the impact modifier may comprise a random terpolymer comprised of units of ethylene, methyl acrylate, and glycidyl methacrylate. It has been discovered that these specific impact modifiers work synergistically with the disclosed flame retardants and/or synergists, see discussion above regarding the glycidyl/epoxy functionality.

In one embodiment, the impact modifier is terpolymeric, comprising polyethylene blocks, methyl acrylate blocks, and glycidyl methacrylate blocks. Specific impact modifiers are a copolymer or terpolymer having units of ethylene, glycidyl methacrylate, and methyl acrylate. It has been discovered that the combination of the specific impact modifiers work synergistically with the non-halogenated flame retardant, optionally in the disclosed amounts and ratios, to provide for the aforementioned combination of performance features.

In some cases, the impact modifier comprises ethylene-methyl acrylate-glycidyl methacrylate terpolymer, methacrylate butadiene styrene rubbers, acrylate rubbers, acrylonitrile-styrene-acrylate rubbers, high rubber graft acrylonitrile-butadiene-styrenes, acrylate-alkene copolymers, polyolefin modifiers, or silicone-acrylic modifiers, or combinations thereof. In some cases, the aforementioned chemical structures may be functionalized, e.g., with maleic anhydride.

Some suitable commercial products are available under the trade name LOTADER ° polymers, sold by SK Chemicals. Some of these are the ethylene-methyl acrylate-glycidyl methacrylate terpolymer (as a backbone) comprising glycidyl methacrylate units commercially available as under the name LOTADER AX8900. Others include LOTADER 4700 and LOTADER 4720, which have the same or similar backbones.

The copolymer/terpolymer may comprise from 0.1 wt % to 50 wt % of acrylate, e.g., glycidyl methacrylate and/or methyl acrylate, units based on the total weight of the copolymer/terpolymer, e.g., from 0.5 wt % to 45 wt %, from 1 wt % to 40 wt %, from 3 wt % to 40 wt %, from 5 wt % to 35 wt %, from 5 wt % to 45 wt %, from 10 wt % to 35 wt %, or from 15 wt % to 35 wt %. In terms of upper limits, the copolymer/terpolymer may comprise less than 50 wt % of acrylate units, e.g., less than 45 wt %, less than 40 wt %, less than 35 wt %, less than 30 wt %, less than 25 wt %, or less than 20 wt %. In terms of lower limits, the copolymer/terpolymer may comprise, based on the total weight of the copolymer/terpolymer, greater than 0.1 wt % of acrylate units, e.g., greater than 0.3 wt %, greater than 0.5 wt %, greater than 1 wt %, greater than 3 wt %, greater than 5 wt %, greater than 10 wt %, greater than 15 wt %, or greater than 20 wt %.

The copolymer/terpolymer may comprise, based on the total weight of the copolymer/terpolymer, from 30 wt % to 80 wt % of alkene, e.g., ethylene, units e.g., from 35 wt % to 75 wt %, from 40 wt % to 70 wt %, from 45 wt % to 65 wt %, from 50 wt % to 60 wt %, or from 52.5 wt % to 57.5 wt %. In terms of upper limits, the copolymer/terpolymer may comprise less than 80 wt % of alkene units, e.g., less than 75 wt %, less than 70 wt %, less than 65 wt %, less than 60 wt %, or less than 57.5 wt %. In terms of upper limits, the copolymer/terpolymer may comprise greater than 30 wt % of alkene units, e.g., greater than 35 wt %, greater than 40 wt %, greater than 45 wt %, greater than 50 wt %, or greater than 52.5 wt %.

In some embodiments, the copolymer/terpolymer may comprise from 0.3 wt % to 12 wt % of glycidyl methacrylate units base on the total weight of the copolymer/terpolymer, e.g., from 0.4 wt % to 11 wt %, from 0.5 wt % to 10 wt %, from 0.6 wt % to 9 wt %, from 0.7 wt % to 8 wt %, from 0.8 wt % to 7 wt %, from 0.9 wt % to 6 wt %, or from 1 wt % to 5 wt %. In terms of upper limits, the copolymer/terpolymer may comprise less than 12 wt % of glycidyl methacrylate units, e.g., less than 11 wt %, less than 10 wt %, less than 9 wt %, less than 8 wt %, less than 7 wt %, or less than 6 wt %. In terms of lower limits, the copolymer/terpolymer may comprise greater than 0.3 wt % of glycidyl methacrylate units, e.g., greater than 0.4 wt %, greater than 0.5 wt %, greater than 0.6 wt %, greater than 0.7 wt %, greater than 0.8 wt %, or greater than 0.9 wt %.

The copolymer/terpolymer may comprise, based on the total weight of the copolymer/terpolymer, from 5 wt % to 35 wt % of methyl acrylate units, e.g., from 7 wt % to 33 wt % of methyl acrylate, from 9 wt % to 31 wt % of methyl acrylate, from 11 wt % to 29 wt % of methyl acrylate, from 13 wt % to 27 wt % of methyl acrylate, or from 15 wt % to 25 wt % of methyl acrylate. In terms of upper limits, the copolymer/terpolymer may comprise less than 35 wt % of methyl acrylate, e.g., less than 33 wt % of methyl acrylate, less than 31 wt % of methyl acrylate, less than 29 wt % of methyl acrylate, less than 27 wt % of methyl acrylate, or less than 25 wt % of methyl acrylate. In terms of lower limits, the copolymer/terpolymer may comprise greater than 5 wt % of methyl acrylate, e.g., greater than 7 wt % of methyl acrylate, greater than 9 wt % of methyl acrylate, greater than 11 wt % of methyl acrylate, greater than 13 wt % of methyl acrylate, or greater than 15 wt % of methyl acrylate.

The concentration of the impact modifier in the polyamide composition can, for example, range from 0.01 wt % to 10 wt %, e.g., from 0.1 wt % to 9 wt %, from 1 wt % to 8 wt %, from 2 wt % to 7 wt %, from 3 wt % to 6 wt %, or from 4 wt % to 5 wt %. In terms of upper limits, the impact modifier concentration can be less than 10 wt %, e.g., less than 9 wt %, less than 8 wt %, less than 7 wt %, less than 6 wt %, or less than 5 wt %. In terms of lower limits, the impact modifier concentration can be greater than 0.01 wt %, greater than 0.1 wt %, greater than 1 wt %, greater than 2 wt %, greater than 3 wt %, greater than 4 wt %, or greater than 4.5 wt %. In some embodiments, the concentration of the impact modifier in the polyamide is less than 5 wt %. In some embodiments, the concentration of the impact modifier is less than 7.5 wt %. The inventors have found that by employing the impact modifier in these amounts provides for advantageous properties, e.g., UL94 performance.

The ratio of the amounts of the impact modifier and the non-halogenated flame retardant in the composition have unexpectedly been found to be particularly important in producing materials having advantageous combinations of electrical and mechanical properties, e.g., strength and ductility properties. The weight ratio of impact modifier to non-halogenated flame retardant in the polyamide composition can, for example range from 0.05 to 2, e.g., from 0.1 to 1.5, from 0.15 to 1, from 0.2 to 0.5, from 0.24 to 0.6 or from 0.22 to 0.4. In terms of upper limits, the weight ratio of impact modifier to non-halogenated flame retardant can be less than 2, e.g., less than 1.5, less than 1, less than 0.6, less than 0.5, or less than 0.4. In terms of lower limits, the weight ratio of impact modifier to non-halogenated flame retardant can be greater than 0.05, e.g., greater than 0.1, greater than 0.11, greater than 0.12, greater than 0.15, greater than 0.2, or greater than 0.22.

The ratio of the amounts of the impact modifier and the reinforcing agent in the composition have also unexpectedly been found to be particularly important in producing materials having advantageous combinations of strength and ductility properties. It is postulated that this ratio is important because lower amounts of glass fibers contribute to improved ductility, which in turn contributes to snap-fit performance. The weight ratio of impact modifier to glass fiber in the polyamide composition can, for example range from 0.05 to 5, e.g., from 0.1 to 4.0, from 0.1 to 2.0, from 0.2 to 2.0, from 0.2 to 1.5, from 0.3 to 1.0, or from 0.3 to 0.9. In terms of upper limits, the weight ratio of impact modifier to glass fiber can be less than 5.0, e.g., less than 4.5, less than 4.0, less than 3.5, less than 3, less than 2.5, less than 2.25, less than 2, less than 1.5, less than 1.0, or less than 0.9. In terms of lower limits, the weight ratio of impact modifier to glass fiber can be greater than 0.05, e.g., greater than 0.1, greater than 0.2, greater than 0.3, greater than 0.5, greater than 1, greater than 1.25, greater than 1.5, or greater than 1.75.

### Non-Halogenated Phosphinate-Based Flame Retardant

The polyamide composition also contains a flame retardant. Generally, non-halogenated flame retardants are used due to a desire to avoid the potentially adverse environmental impact of halogenated flame retardants. The disclosed flame retardants work synergistically with the other components to provide the aforementioned combinations of performance features.

Exemplary non-halogenated flame retardants include phosphorus- or melamine-containing flame retardants. Phosphate esters are especially suitable for use. Such compounds include, for example, alkyl and aryl esters of phosphoric acid such as trimethyl phosphate, triethyl phosphate, tributyl phosphate, trioctyl phosphate, tributoxyethyl phosphate, triphenyl phosphate, tricresyl phosphate, cresyldiphenyl phosphate, octyldiphenyl phosphate, tri(2-ethylhexyl) phosphate, di-iso-propylphenyl phosphate, trixylenyl phosphate, tris(iso-propylphenyl) phosphate, trinaphthyl phosphate, bisphenol A diphenyl phosphate, and resorcinol diphenyl phosphate. Metal salts of these compounds are also contemplated.

Commonly used triaryl phosphates include, for example, triphenyl phosphate (TPP), cresyl diphenyl phosphate, and tricresyl phosphate. Inorganic phosphate flame retardants such as ammonium polyphosphate (which acts as an intumescent flame retardant) may also be utilized. Hexaphenoxycyclotriphosphazene (phenoxyphosphazene oligomer), such as Fushimi Pharmaceutical Co. Rabitle FP-100 (high purity), Rabitle FP-110 (standard grade) exhibit high thermal stability and can be used with these aromatic polyamides.

Exemplary flame retardants include those disclosed in US Publication Nos. 20060089435A1; 20200165416A1; US20180244899A1; and US20190153197A1.

In some embodiments, the flame retardant comprises dialkyl phosphinates (and/or metal salts, e.g., aluminum salts, thereof). One particular example is the aluminum salt of diethyl phosphinate a/k/a DEPAL.

Combinations of the various flame retardants mentioned herein and in these documents are also contemplated.

Exemplary commercial products include those sold by Clariant under the Exolit® tradename, e.g., OP1230, OP1400, OP1312, OP1380, or others.

In some embodiments, the concentration of the non-halogenated phosphinate-based flame retardant ranges from 0.01 wt % to 24 wt %, based on the total weight of the polymer composition, e.g., from 1 wt % to 23 wt %, from 2 wt % to 22 wt %, from 5 wt % to 21 wt %, from 6 wt % to 20 wt %, from 7 wt % to 19 wt %, from 8 wt % to 18 wt %, or from 10 wt % to 15 wt %. In terms of upper limits, the concentration of the flame retardant may be less than 24 wt %, e.g., less than 23 wt %, less than 22 wt %, less than 21 wt %, less than 20 wt %, less than 19 wt %, less than 18 wt %, or less than 15 wt %. In terms of lower limits, the concentration of the flame retardant may be greater than 0.01 wt %, e.g., greater than 1 wt %, greater than 2 wt %, greater than 5 wt %, greater than 6 wt %, greater than 7 wt %, greater than 8 wt %, or greater than 10 wt %. Lower concentrations, e.g., less than 0.01 wt %, are also contemplated.

### Synergist

In addition to the phosphinate flame retardant, the non-halogenated flame retardant may also contain a flame retardant synergist (FR synergist). Flame retardant synergists are employed to increase the effectiveness of the flame retardant. These synergists are commonly employed as non-halogenated char-forming agents and/or smoke suppressants in combination with phosphinate flame retardants. The inventors have found that the inclusion of these synergists may provide desirable performance characteristics, such as improved glow wire ignition testing (GWIT) performance. One particular suitable flame retardant synergist base is melamine, which contains three carbon atoms in a ring structure substituted with an amino functional group.

Such melamine-based flame retardant synergists may comprises melamine phosphate, dimelamine phosphate, melamine pyrophosphate, melamine polyphosphates, melam polyphosphates, melem polyphosphates, and/or melon polyphosphates. The flame retardant synergists may also comprise melamine condensates, e.g., high thermal stability nitrogen compounds, such as Melam (1,3,5-triazine-2,4,6-triamine-n-(4,6-diamino-1,3,5-triazine-2-yl), Melem (2,5,8-triamino-tri-s-triazine), and Melon (poly[8-amino-1,3,4,6,7,9,9b-Heptaazaphenalene-2,5-diyl)imino).

In some embodiments, the flame retardant synergist is melamine polyphosphate, which is commercially available from BASF under the name MELAPUR®, e.g., MELAPUR 200 or from Budenheim under the name Budit® 341 or 342.

In some cases, the compositions comprise the synergist, but do not comprise the impact modifier. For example, the composition comprises polyamide, flame retardant, synergist, and reinforcing agent.

In some cases, the compositions comprise the impact modifier, but do not comprise the synergist. For example, the composition comprises polyamide, flame retardant, impact modifier, and reinforcing agent.

In some embodiments, the concentration of the flame retardant synergist, e.g., the melamine-based flame retardant synergist, ranges from 0.01 wt % to 20 wt %, based on the total weight of the polyamide composition, e.g., from 0.1 wt % to 15 wt %, from 0.1 wt % to 10 wt %, from 0.1 wt % to 5 wt %, from 1 wt % to 9 wt %, from 2 wt % to 8 wt %, from 3 wt % to 7 wt %, or from 4 wt % to 6 wt %. In terms of upper limits, the concentration of the flame retardant may be less than 20 wt %, e.g., less than 10 wt %, less than 9 wt %, less than 8 wt %, less than 7 wt %, or less than 6 wt %. In terms of lower limits, the concentration of the flame retardant may be greater than 0.01 wt %, e.g., greater than 0.1 wt %, greater than 1 wt %, greater than 2 wt %, greater than 3 wt %, or greater than 4 wt %.

In some embodiments, the combined concentration of the non-halogenated phosphinate-based flame retardant and the (melamine-based) flame retardant synergist ranges from 0.01 wt % to 40 wt %, e.g., from 1 wt % to 35 wt %, from 2 wt % to 34 wt %, from 4 wt % to 32 wt %, from 5 wt % to 31 wt %, from 7 wt % to 29 wt %, from 8 wt % to 28 wt %, or from 9 wt % to 27 wt %. In terms of upper limits, the combined concentration of the phosphinate flame retardant and the melamine-based flame retardant synergist is less than 40 wt %, e.g., less than 35 wt %, less than 34 wt %, less than 32 wt %, less than 31 wt %, less than 29 wt %, less than 28 wt %, or less than 27 wt %. In terms of lower limits, the combined concentration of the non-halogenated phosphinate-based flame retardant and the melamine-based flame retardant synergist is greater than 0.01 wt %, e.g., greater than 1 wt %, greater than 2 wt %, greater than 4 wt %, greater than 5 wt %, greater than 7 wt %, greater than 8 wt %, or greater than 9 wt %.

### Polyamide

As used herein, a “polyamide” refers to a polymer, having as a component, a polymer with the linkage of an amino group of one molecule and a carboxylic acid group of another molecule. In some aspects, the polyamide is the component present in the greatest amount. For example, a polyamide containing 40 wt. % nylon 6, 30 wt. % polyethylene, and 30 wt. % polypropylene is referred to herein as a polyamide since the nylon 6 component is present in the greatest amount. Additionally, a polyamide containing 20 wt. % nylon 6, 20 wt. % nylon 66, 30 wt. % polyethylene, and 30 wt. % polypropylene is also referred to herein as a polyamide since the nylon 6 and nylon 66 components, in total are the components present in the greatest amount. In some cases, the polyamide is a pure polyamide and does not contain any non-polyamide units.

There are numerous advantages of using polyamides in commercial applications. Nylons are generally chemical and temperature resistant, resulting in superior performance to other polymers. They are also known to have improved strength, elongation, and abrasion resistance as compared to other polymers. Nylons are also very versatile, allowing for their use in a variety of applications.

The polyamide of the disclosed composition can vary widely and can include one polyamide polymer or two or more polyamides. Common polyamides include nylons and aramids. For example, the polyamide may comprise PA-4T/4I; PA-4T/6I; PA-5T/5I; PA-6; PA-66; PA-6,6/6; PA-6,6/6T; PA-6,6/6I, PA-6I/6T; PA-6T/6I; PA-6T/6I/6; PA-6T/6; PA-6T/6I/66; PA-6T/MPMDT (where MPMDT is polyamide based on a mixture of hexamethylene diamine and 2-methylpentamethylene diamine as the diamine component and terephthalic acid as the diacid component); PA-6T/66; PA-10; PA-12; PA610, PA612; PA-6T/610; PA-10T/612; PA-10T/106; PA-6T/612; PA-6T/10T; PA-6T/10I; PA-9T; PA-10T; PA-12T; PA-10T/10I; PA-10T/12; PA-10T/11; PA-6T/9T; PA-6T/12T; PA-6T/10T/6I; PA-6T/6I/6; PA-66/6C; PA-6T/61/12; and copolymers, blends, mixtures and/or other combinations thereof. This listing is exemplary and is not limiting. Additional suitable polyamides, additives, and other components are disclosed in U.S. patent application Ser. No. 16/003,528.

The one or more polyamide polymers of the composition can include aliphatic polyamides such as polymeric ε-caprolactam (PA6) and polyhexamethylene adipamide (PA66) or other aliphatic nylons, polyamides with aromatic components such as paraphenylenediamine and terephthalic acid, and copolymers such as adipate with 2-methyl pentmethylene diamine and 3,5-diacarboxybenzenesulfonic acid or sulfoisophthalic acid in the form of its sodium sultanate salt. The polyamides can include polyaminoundecanoic acid and polymers of bis-paraaminocyclohexyl methane and undecanoic acid. Other polyamides include poly(aminododecanoamide), polyhexamethylene sebacamide, poly(p-xylyleneazeleamide), poly(m-xylylene adipamide), and polyamides from bis(p-aminocyclohexyl)methane and azelaic, sebacic and homologous aliphatic dicarboxylic acids. As used herein, the terms “PA6 polymer” and “PA6 polyamide polymer” also include copolymers in which PA6 is the major component. As used herein the terms “PA66 polymer” and “PA66 polyamide polymer” also include copolymers in which PA66 is the major component. In some embodiments, copolymers such as PA-6,6/6I; PA-6I/6T; or PA-6,6/6T, or combinations thereof are contemplated for use as the polyamide polymer. In some cases, physical blends, e.g., melt blends, of these polymers are contemplated. In some cases, the polyamide polymer comprises PA-6, or PA-6,6, or a combination thereof. In some cases, the polyamide polymer comprises PA-6,12, or PA-6,10, or a combination thereof.

The polyamide compositions can include polyamides produced through the ring-opening polymerization or polycondensation, including the copolymerization and/or copolycondensation, of lactams. These polyamides can include, for example, those produced from propriolactam, butyrolactam, valerolactam, and caprolactam. For example, in some embodiments, the composition may include a polyamide polymer derived from the polymerization of caprolactam.

The polyamide composition can include a combination of polyamides. By combining various polyamides, the final composition can incorporate the desirable properties, e.g., mechanical properties, of each constituent polyamides. The combination of polyamides could include any number of known polyamides. In some embodiments, the polyamide composition includes a combination of PA6 and PA66, preferably present in the amounts discussed herein. In certain aspects, the polyamide composition includes from 45 wt % to 55 wt % PA66 polyamide polymer and less than 12 wt % PA6 polyamide polymer. The polyamide composition can also include combinations of any of the PA6 and PA66 percentages described herein.

The concentration of the one or more polyamide polymers in the polyamide composition can, for example, range from 5 wt % to 85 wt %, e.g., from 5 wt % to 85 wt %, from 10 wt % to 80 wt %, from 15 wt % to 75 wt %, from 20 wt % to 70 wt %, from 25 wt % to 65 wt %, from 30 wt % to 60 wt %, from 35 wt % to 55 wt %, or from 40 wt % to 50 wt %. In some embodiments, the concentration of the one or more polyamide polymers ranges from 30 wt % to 60 wt %. In terms of upper limits, the combined polyamide polymer concentration can be less than 85 wt %, e.g., less than 80 wt %, less than 75 wt %. less than 70 wt %, less than 65 wt %, less than 60 wt %, less than 55 wt %, less than 50 wt %, less than 45 wt %, less than 40 wt %, less than 35 wt %, less than 30 wt %, less than 25 wt %, less than 20 wt %, less than 15 wt %, or less than 10 wt %. In terms of lower limits, the combined polyamide polymer concentration can be greater than 5 wt %, e.g., greater than 10 wt %, greater than 15 wt %, greater than 20 wt %, greater than 25 wt %, greater than 30 wt %, greater than 35 wt %, greater than 40 wt %, greater than 45 wt %, greater than 50 wt %, greater than 55 wt %, greater than 60 wt %, greater than 65 wt %, greater than 70 wt %, greater than 75 wt %, or greater than 80 wt %. Lower concentrations, e.g., less than 5 wt %, and higher concentrations, e.g., greater than 85 wt %, are also contemplated. In some cases, the ranges and limits disclosed for the one or more polyamide polymers are applicable to the PA66.

In certain aspects, the one or more polyamide polymers includes a PA66 polymer. The concentration of the PA66 polymer in the one or more polyamide polymers can, for example, range from 0 wt % to 100 wt %, e.g., from 0 wt % to 60 wt %, from 10 wt % to 70 wt %, from 20 wt % to 80 wt %, from 30 wt % to 90 wt %, or from 40 wt % to 100 wt %. In some embodiments, the one or more polyamide polymers includes from 40 wt % to 60 wt % PA66 polymer. In terms of upper limits, the PA66 polymer concentration in the one or more polyamide polymers can be less than 100 wt %, e.g., less than 90 wt %, less than 80 wt %, less than 70 wt %, less than 60 wt %, less than 50 wt %, less than 40 wt %, less than 30 wt %, less than 20 wt %, or less than 10 wt %. In terms of lower limits, the PA66 polymer concentration in the one or more polyamide polymers can be greater than 0 wt %, e.g., greater than 10 wt %, greater than 20 wt %, greater than 30 wt %, greater than 40 wt %, greater than 50 wt %, greater than 60 wt %, greater than 70 wt %, greater than 80 wt %, or greater than 90 wt %.

In certain aspects, the one or more polyamide polymers includes a PA6 polymer. The concentration of the PA6 polymer in the one or more polyamide polymers can, for example, range from 0 wt % to 100 wt %, e.g., from 0 wt % to 60 wt %, from 10 wt % to 70 wt %, from 20 wt % to 80 wt %, from 0.1 wt % to 25 wt %, from 1 wt % to 20 wt %, from 1 wt % to 15 wt %, from 3 wt % to 13 wt %, from 5 wt % to 15 wt %, from 7 wt % to 13 wt %, from 30 wt % to 90 wt %, or from 40 wt % to 100 wt %. In some embodiments, the one or more polyamide polymers includes from 0 wt % to 20 wt % PA6 polymer. In terms of upper limits, the PA6 polymer concentration in the one or more polyamide polymers can be less than 100 wt %, e.g., less than 90 wt %, less than 80 wt %, less than 70 wt %, less than 60 wt %, less than 50 wt %, less than 40 wt %, less than 30 wt %, less than 25 wt %, less than 20 wt %, less than 15 wt %, less than 13 wt %, or less than 10 wt %. In terms of lower limits, the PA6 polymer concentration in the one or more polyamide polymers can be greater than 0 wt %, e.g., greater than 0.1 wt %, greater than 1 wt %, greater than 3 wt %, greater than wt %, greater than 7 wt %, greater than 10 wt %, greater than 20 wt %, greater than 30 wt %, greater than 40 wt %, greater than 50 wt %, greater than 60 wt %, greater than 70 wt %, greater than 80 wt %, or greater than 90 wt %.

The one or more polyamides each independently have a specific configuration of end groups, such as, for example, amine end groups, carboxylate end groups and so-called inert end groups including mono-carboxylic acids, mono amines, lower dicarboxylic acids capable of forming inert imine end groups, phthalic acids and derivatives thereof. It has been found that in some aspects, the polymer end groups can be selected to specifically interact with the impact modifier of the composition, affecting dispersion and resulting mechanical properties.

In addition to the compositional make-up of the polyamide mixture, it has also been discovered that the relative viscosities of the one or more amide polymers can provide surprising benefits, both in performance and processing. For example, if the relative viscosity of the amide polymer is within certain ranges and/or limits, production rates and tensile strength (and optionally impact resilience) are improved.

In some embodiments, the RV of the polyamide composition ranges from 5 to 80, e.g., from 5 to 70, from 10 to 70, from 15 to 65, from 20 to 60, from 30 to 50, from 10 to 35, from 10 to 20, from 60 to 70, from 50 to 80, from 40 to 50, from 30 to 60, from 5 to 30, or from 15 to 32. In terms of lower limits, the RV of the polyamide composition may be greater than 5, e.g., greater than 10, greater than 15, greater than 20, greater than 25, greater than 27.5, or greater than 30. In terms of upper limits, the RV of the polyamide composition may be less than 70, e.g., less than 65, less than 60, less than 50, less than 40, or less than 35.

To calculate RV, a polyamide may be dissolved in a solvent (usually formic or sulfuric acid), the viscosity is measured, then the viscosity is compared to the viscosity of the pure solvent. This give a unitless measurement. Solid materials, as well as liquids, may have a specific RV. This measurement is well-known in the art.

### Reinforcing Agent

Some embodiments of the flame retardant polyamide composition comprises a reinforcing agent. The material of the reinforcing agent is not particularly limited and may be selected from fibers/fillers known in the art, e.g., glass fibers.

In some cases, the combination of the impact modifier/flame retardant and the reinforcing agent, optionally in the disclosed amounts and ratios, provides for surprising, synergistic combinations of performance features, e.g., tensile/flexural performance and impact resistance.

The reinforcing agents can include any materials known for these uses. For example, suitable reinforcing agents and include silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); single crystal fibers or “whiskers” such as silicon carbide, alumina, boron carbide, iron, nickel, copper, or the like; fibers (including continuous and chopped fibers) such as carbon fibers, glass fibers, such as E glass, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked reinforcing agents such as glass flakes, flaked silicon carbide, aluminum diboride, aluminum flakes, steel flakes or the like; fibrous reinforcing agents, for example short inorganic fibers such as those derived from blends comprising at least one of aluminum silicates, aluminum oxides, magnesium oxides, and calcium sulfate hemihydrate or the like; natural reinforcing agents and reinforcements, such as wood flour obtained by pulverizing wood, fibrous products such as cellulose, cotton, sisal, jute, starch, cork flour, lignin, ground nut shells, corn, rice grain husks or the like; reinforcing organic fibrous reinforcing agents formed from organic polymers capable of forming fibers such as poly(ether ketone), polyimide, polybenzoxazole, poly(phenylene sulfide), aromatic polyamides, aromatic polyimides, polyetherimides, or the like; as well as additional reinforcing agents such as mica, feldspar, flue dust, fillite, quartz, quartzite, perlite, tripoli, diatomaceous earth, carbon black, or the like, or combinations comprising at least one of the foregoing reinforcing agents.

The reinforcing agents may be coated with a layer of metallic material to facilitate conductivity, or surface treated with silanes to improve adhesion and dispersion with the polymeric matrix resin. In addition, the reinforcing agents may be provided in the form of monofilament or multifilament fibers and may be used either alone or in combination with other types of fiber, though, for example, co-weaving or core/sheath, side-by-side or matrix and fibril constructions, or by other methods known to one skilled in the art of fiber manufacture. Suitable cowoven structures include, for example, glass fiber-carbon fiber, carbon fiber-aromatic polyimide (aramid) fiber, and aromatic polyimide fiberglass fiber or the like. Fibrous reinforcing agents may be supplied in the form of, for example, rovings, woven fibrous reinforcements, such as 0-90 degree fabrics or the like; non-woven fibrous reinforcements such as continuous strand mat, chopped strand mat, tissues, papers and felts or the like; or three-dimensional reinforcements such as braids. In some aspects, the composition is free of a layered silicate.

The concentration of reinforcing agents in the flame retardant polyamide composition can, for example, range from 5 wt % to 60 wt %, e.g., from 6 wt % to 50 wt %, from 7 wt % to 40 wt %, from 8 wt % to 30 wt %, or from 9 wt % to 20 wt %. In terms of upper limits, the glass fiber concentration can be less than 60 wt %, e.g., less than 50 wt %, less than 40 wt %, less than 30 wt %, less than 25 wt %, less than 20 wt %, less than 17.5 wt %, less than 16 wt %, less than 15 wt %, less than 12.5 wt %, less than 10 wt %, or less than 8 wt %. In terms of lower limits, the glass fiber concentration can be greater than 5 wt %, e.g., greater than 6 wt %, greater than 7 wt %, greater than 7.5 wt %, greater than 8 wt %, greater than 8.5 wt %, greater than 9 wt %, greater than 9.5 wt %, greater than 10 wt %, greater than 11 wt %, greater than 12 wt %, greater than 12.5 wt %, greater than 13 wt %, greater than 13.5 wt %, greater than 14 wt %, or greater than 14.5 wt %. Lower concentrations, e.g., less than 5 wt %, and higher concentrations, e.g., greater than 60 wt %, are also contemplated.

As noted above, in some cases, the combination of components is particularly beneficial for lower reinforcing agent loadings, e.g., less than 30 wt %, less than 20 wt %, less than 16 wt %, or less than 15 wt %. Advantageously, these compositions (with lower reinforcing agent loading) unexpectedly provide for improvements in ductility, while also demonstrating the aforementioned performance benefits.

Glass fibers are particularly suitable due to their inherent electrically insulative nature. Contemplated glass fibers include E-glass, A-glass, C-glass, D-glass, AR-glass, S1-glass, S2-glass, etc., and mixtures thereof.

The glass fiber can include long fibers, e.g., greater than 6 mm, greater than 7 mm, greater than 8 mm, or greater than 10 mm; short fibers, e.g., less than 6 mm, less than 5 mm, or less than 3 mm; or combinations thereof. The glass fiber can be milled.

In some embodiments, the glass fibers may have a relatively small median diameter, such as about 50 micrometers or less, e.g., from about 0.1 to about 40 micrometers, from about 1 to about 20 micrometers, or from about 2 to about 15 micrometers. It is believed that the small diameter of such glass fibers can allow their length to be more readily reduced during melt blending, which can improve mechanical properties.

The amount of glass fiber in the polyamide composition relative to the amounts of the other composition components can be selected to advantageously provide additional strength without negatively affecting material ductility. See discussion above regarding weight ratio of impact modifier to reinforcing agent.

### Additives

In some aspects, the composition may also include various additives such as reinforcing agents, stabilizers, heat stabilizers, colorants, lubricants, antioxidants, light stabilizers, and the like, with the proviso that the additives do not adversely affect the desired properties of the flame retardant polyamide compositions. Mixtures of additives may be used. Such additives may be mixed at a suitable time during the mixing of the components for forming the polyamide composition.

An antioxidant or “stabilizer,” e.g., a hindered phenol and/or secondary aryl amine and, optionally, a secondary antioxidant, e.g., a phosphate and/or thioester, may also be included as an additive. Suitable antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; N,N′-hexane-1,6-diylbis(3-(3,5-di-tert-butyl-4-hydroxyphenylpropionamide)); alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants.

Suitable commercially available antioxidants may include Irganox, available from BASF, and Irgafos, available from BASF, for example. Light stabilizers and/or ultraviolet light (UV) absorbing additives may also be used. Suitable light stabilizer additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers.

Suitable UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than about 100 nanometers; or the like, or combinations comprising at least one of the foregoing UV absorbers based on 100 parts by weight of the polymeric components of the polymeric composition.

Plasticizers, lubricants, and/or mold release agents additives may also be used. There is considerable overlap among these types of materials, which include, for example, phthalic acid esters such as dioctyl-4,5-epoxy-hexahydrophthalate; tris-(octoxycarbonylethyl)isocyanurate; tristearin; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; aluminum salts, e.g., aluminum stearate; mixtures of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like.

Colorants such as pigment and/or dye additives may also be present. Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations comprising at least one of the foregoing pigments.

These additives, when present, may be present in an amount of greater than 0.01 wt %, e.g., greater than 0.05 wt %, greater than 0.075 wt %, greater than 0.1 wt %, greater than 0.15 wt %, greater than 0.20 wt %, or greater than 0.25 wt %. In terms of upper limits, the additives may be present in an amount from 4 wt. % or less, from 3 wt. % or less, from 2.75 wt. % or less, from 2.5 wt. % or less. from 2.25 wt % or less, or from 2 wt % or less. In terms of ranges, the additives may be present in an amount from 0.01 to 4 wt. %, e.g., from 0.05 to 3 wt. %, from 0.1 to 2.75 wt. %, from 0.15 to 2.5 wt. %, from 0.20 wt % to 2.25 wt %, or from 0.25 wt % to 2 wt %.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

Some of the components and steps disclosed herein may be considered optional. In some cases, the disclosed compositions, processes, etc. may expressly exclude one or more of the aforementioned components or steps in this description, e.g., via claim language. This is contemplated herein by the inventors. For example, claim language may be modified to recite that the disclosed compositions, processes, streams, etc., do not utilize or comprise one or more of the aforementioned components or steps, e.g., the flame retardant polyamide composition does not include an impact modifier. Such negative limitations are contemplated, and this text serves as support for negative limitations for components, steps, and/or features.

### Methods of Preparation

One or more polyamides, reinforcing agents, impact modifier, non-halogenated flame retardant, and other optional additives can be mixed and blended together to produce the polyamide composition, or can be formed in situ using appropriate reactants. The terms “adding” or “combining” without further clarification are intended to encompass either the addition of the material itself to the composition or the in situ formation of the material in the composition. In another embodiment, two or more materials to be combined with the composition are simultaneously added via masterbatch.

The reinforcing agents may optionally be added at a location downstream from the point at which the polyamide is supplied. If desired, the flame retardant may also be added to downstream from the point at which the polyamide is supplied.

### Molded Articles

The present disclosure also relates to articles that include any of the provided non-halogenated flame retardant polyamide compositions. The article can be produced, for example, via conventional injection molding, extrusion molding, blow molding, press molding, compression molding, or gas assist molding techniques. Molding processes suitable for use with the disclosed compositions and articles are described in U.S. Pat. Nos. 8,658,757; 4,707,513; 7,858,172; and 8,192,664, each of which is incorporated herein by reference in its entirety for all purposes. Examples of articles that can be made with the provided polyamide compositions include those used in electrical and electronic applications (such as, but not limited to, circuit breakers, terminal blocks, connectors and the like), furniture and appliance parts, and wire positioning devices such as cable ties.

In some cases, the inventors have discovered that the disclosed polyamide compositions are particularly suitable for making connectors, e.g., snap-fit connectors and/or for unattended devices, e.g., unattended household appliances, that must be able to withstand the criteria of IEC 60695-2-11.

The inventors have further discovered that the disclosed polyamide compositions are particularly suitable for use in electrical connectors, such as those employed in household and industrial appliances.

The present invention may be better understood with reference to the following examples.

### Test Methods

Tensile Modulus, Tensile Stress, and Tensile Elongation at Break: Tensile properties may be tested according to ISO Test No. 527:2012 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

The disclosed compositions may demonstrate an elongation at break greater 2.7%, e.g., greater than 2.9%, greater than 3.0%, greater than 3.2%, greater than 3.5%, greater than 3.7%, greater than 4.0%, or greater than 4.2%.

The disclosed compositions may demonstrate tensile modulus greater than 3500 MPa, e.g., greater than 3700, greater than 4000, greater than 4300, greater than 4500, greater than 4800, greater than 5000, greater than 5300, or greater than 5500.

The disclosed compositions may demonstrate tensile strength greater than 60 MPa, e.g., greater than 65, greater than 70, greater than 75, greater than 80, greater than 85, or greater than 90.

Unnotched Izod Impact Strength: Unnotched Izod properties may be tested according to ISO Test No. ISO 179-1:201 0) (technically equivalent to ASTM D256-10, Method B). This test may be run using a Type 1 specimen size (length of 80 mm, width of 10 mm, and thickness of 4 mm). Specimens may be cut from the center of a multi-purpose bar using a single tooth milling machine. The testing temperature may be 23° C.

The disclosed compositions may demonstrate unnotched Izod impact strength greater than 25 kJ/m², e.g., greater than 27, greater than 30, greater than 33, greater than 35, greater than 38, or greater than 40.

Notched Izod Impact Strength: Notched Izod properties may be tested according to ASTM D256-10. This test may be run using a Type 1 specimen size (length of 80 mm, width of 10 mm, and thickness of 4 mm). Specimens may be cut from the center of a multi-purpose bar using a single tooth milling machine. The testing temperature may be 23° C.

The disclosed compositions may demonstrate notched Izod impact strength greater than 3.5 kJ/m², e.g., greater than 4, greater than 4.25, greater than 4.5, greater than 4.75, greater than 5.0, greater than 5.25, greater than 5.5, or greater than 5.75.

Charpy Notched Impact Resistance: Charpy notched impact strength may be tested using a standard protocol such as ISO 179-1 (2010). The testing temperature may be 23° C.

The disclosed compositions may demonstrate notched Charpy impact strength greater than 3.5 kJ/m², e.g., greater than 4, greater than 4.25, greater than 4.5, greater than 4.75, greater than 5.0, greater than 5.25, greater than 5.5, or greater than 5.75.

The disclosed compositions may demonstrate unnotched Charpy impact strength greater than 25 kJ/m², e.g., greater than 27, greater than 30, greater than 33, greater than 35, greater than 38, greater than 40, greater than 43, greater than 45, greater than 47, or greater than 50.

Flexural Properties: Flexural properties such as flexural stress, strain, and modulus may be measured according to ISO 178. The test uses a universal testing machine and a three point bend fixture to bend plastic test bars to acquire the data needed to assess flexibility.

The disclosed compositions may demonstrate flexural stress of greater than 120 MPa, e.g., greater than 125 MPa, greater than 130 MPa, greater than 131 MPa, greater than 132 MPa, greater than 133 MPa, greater than 134 MPa, greater than 135 MPa, greater than 136 MPa, greater than 137 MPa, greater than 138 MPa, greater than 139 MPa, greater than 140 MPa, or greater than 142 MPa, greater than 145 MPa, or greater than 150 MPa.

The disclosed compositions may demonstrate flexural modulus of greater than 3500 MPa, 4000 MPa, greater than 4100 MPa, greater than 4200 MPa, greater than 4300 MPa, greater than 4400 MPa, greater than 4500 MPa, greater than 4600 MPa, greater than 4700 MPa, greater than 4800 MPa, greater than 4900 MPa, or greater than 5000 MPa.

Heat Deflection Temperature (“HDT”): HDT is defined as the temperature where the sample specimen bends 0.25 mm under a given weight. It can be measured with ISO 175 method A (1.80 MPa), B (0.45 MPa), or C (8.00 MPa).

The disclosed compositions may demonstrate HDT of greater than 150° C., e.g., greater than 160° C., greater than 170° C., greater than 180° C., greater than 190° C., greater than 200° C., greater than 210° C., greater than 220° C., greater than 230° C., greater than 240° C., or greater than 250° C.

Melting Point: Melting point may be measured by differential scanning calorimetry (DSC) according to ISO 3146.

The disclosed compositions may demonstrate a melting point greater than 150° C., e.g., greater than 160° C., greater than 170° C., greater than 180° C., greater than 190° C., greater than 200° C., greater than 210° C., greater than 220° C., greater than 230° C., greater than 240° C., greater than 250° C., greater than 260° C., greater than 270° C., greater than 280° C., greater than 290° C., or greater than 300° C.

Comparative Tracking Index (“CTI”): The comparative tracking index may be determined in accordance with International Standard IEC 60112-2003 to provide a quantitative indication of the ability of a composition to perform as an electrical insulating material under wet and/or contaminated conditions. In determining the CTI rating of a composition, two electrodes are placed on a molded test specimen. A voltage differential is then established between the electrodes while a 0.1% aqueous ammonium chloride solution is dropped onto a test specimen. The maximum voltage at which five specimens withstand the test period for 50 drops without failure is determined. The test voltages range from 100 to 600 V in 25 V increments. The numerical value of the voltage that causes failure with the application of fifty (50) drops of the electrolyte is the CTI. The value provides an indication of the relative track resistance of the material. An equivalent method for determining the CTI is ASTM D-3638-12.

UL94: A specimen is supported in a vertical position and a flame is applied to the bottom of the specimen. The flame is applied for ten seconds and then removed until flaming stops, at which time the flame is reapplied for another ten seconds and then removed. Two sets of five specimens are tested. The samples are generally tested at different widths, e.g., 0.4 mm, 0.8 mm and 1.6 mm. The two sets are conditioned before and after aging. For unaged testing, each thickness is tested after conditioning for 48 hours at 23° C. and 50% relative humidity. For aged testing, five samples of each thickness are tested after conditioning for 7 days at 70° C. The disclosed compositions may demonstrate a V0 or V1 or V2 score.

Glow Wire Ignition Test: This test measures the temperature at which the composition will ignite and burn for longer than 5 seconds when placed into contact with a heated test plate can be measured. This temperature is known as the Glow Wire Ignition Temperature (“GWIT”) and is determined in accordance with IEC-60695-2-13:2010 at a part thickness such as noted above, e.g., from about 0.4 to about 3.2 millimeters. The disclosed compositions may demonstrate a passing GWIT score. The disclosed compositions may demonstrate a passing GWIT score at the desired temperature.

Glow Wire End Product Test: This test measures the end product formed from the composition in a PASS/FAIL setup, wherein a glow wire at a temperature of 750° C. is applied to the end product for 30 seconds. A maximum flame duration must be <2 seconds. The end product is measured at three different directions (x, y, and z-plane). If the flame persists for <2 seconds, the end product receives a “PASS” for that measured direction in accordance with IEC-60695-2-11:2021. Parts made from the disclosed compositions may demonstrate a passing GWEPT score at the desired temperature.

Glow Wire Flammability Index Test (“GWFI”): In the GWFI test, a glowing wire is used at temperatures of 550 to 960° C. to determine, on 3 test specimens, e.g., between 4 to 60 mm, the maximum temperature at which an afterflame time of 30 seconds is not exceeded and no flaming drops come from the specimen. The glow wire is applied to the test specimens, and 3 successive tests must not cause ignition even during the time of exposure to the glow wire. Ignition means a flame with flame time 5 sec. This test is done in accordance with IEC 60695-2-12. The disclosed compositions may demonstrate a passing GWFI score at the desired temperature.

| Vertical | |
|---|---|
| Ratings | Requirements |
| V-0 | Specimens must not burn with flaming combustion for more than 10 seconds after |
| | either test flame application. |
| | Total flaming combustion time must not exceed 50 seconds for each set of 5 |
| | specimens. |
| | Specimens must not burn with flaming or glowing combustion up to the specimen |
| | holding clamp. |
| | Specimens must not drip flaming particles that ignite the cotton. |
| | No specimen can have glowing combustion remain for longer than 30 seconds |
| | after removal of the test flame. |
| V-1 | Specimens must not burn with flaming combustion for more than 30 seconds after |
| | either test flame application. |
| | Total flaming combustion time must not exceed 250 seconds for each set of 5 |
| | specimens. |
| | Specimens must not burn with flaming or glowing combustion up to the specimen |
| | holding clamp. |
| | Specimens must not drip flaming particles that ignite the cotton. |
| | No specimen can have glowing combustion remain for longer than 60 seconds |
| | after removal of the test flame. |
| V-2 | Specimens must not burn with flaming combustion for more than 30 seconds after |
| | either test flame application. |
| | Total flaming combustion time must not exceed 250 seconds for each set of 5 |
| | specimens. |
| | Specimens must not burn with flaming or glowing combustion up to the specimen |
| | holding clamp. |
| | Specimens can drip flaming particles that ignite the cotton. |
| | No specimen can have glowing combustion remain for longer than 60 seconds |
| | after removal of the test flame. |

### EXAMPLES

### Examples 1-2: Flame Retardancy and Glow Wire Ignition Testing

Polyamide formulations of Examples 1 and 2 were prepared. These Examples comprised PA66 along with the additional components shown in Table 1, e.g., PA6, reinforcing agent (glass fibers), release agents (aluminum stearate), antioxidants (Irganox 1098 and Irgafos 168), flame retardant synergists (MELAPUR 200, a melamine polyphosphate (MPP) available from BASF), impact modifiers (Lotader AX8900, an ethylene/acrylic ester/glycidyl methacrylate terpolymer, available from SK Chemicals). Each of the Examples further comprised a commercially available non-halogenated phosphinate-based flame retardant as described herein (organic phosphinate-containing flame retardants, e.g., the Exolit product line from Clariant). Comparative Examples A, B, and C were prepared without the FR synergist and with varying amounts of the flame retardant and impact modifier.

TABLE 1

| | Comp. | Comp. | Comp. | | |
|---|---|---|---|---|---|
| Component (wt %) | Ex. A | Ex. B | Ex. C | Ex. 1 | Ex. 2 |
| PA-66 | balance | balance | balance | balance | balance |
| PA-6 | 10 | 10 | 10 | 10 | 10 |
| Glass fibers | 15 | 15 | 15 | 15 | 15 |
| FR (phosphinate) | 21 | 24 | 24 | 21 | 21 |
| FR synergist | 0 | 0 | 0 | 5 | 5 |
| Impact modifier | 0 | 0 | 5 | 0 | 5 |
| Aluminum stearate | 0.25 | 0.25 | 0.25 | 0.25 | 0.25 |
| Antiox. (Irganox 1098) | 0.25 | 0.25 | 0.25 | 0.25 | 0.25 |
| Antiox. (Irgafos 168) | 0.2 | 0.2 | 0.2 | 0.2 | 0.2 |

The formulations described above were formed into coupons and tested for the performance properties, e.g., mechanical and electrical properties. The results are shown in Table 2. GWFI scores of at least 2 seconds were deemed acceptable. For flame out time, pass criteria were that each individual flame out time was below 30 seconds there was no burning drip present.

TABLE 2

| Test | Comp. Ex. A | Comp. Ex. B | Comp. Ex. C | Ex. 1 | Ex. 2 |
|---|---|---|---|---|---|
| GWFI 960° C.; @1.6 mm | Not tested | Pass | Pass | Pass | Pass |
| GWIT 775° C.; @1.6 mm | Fail | Fail | Fail | Pass | Pass |
| UL94 V0 @0.8 mm | V1 | V0 | V0 | V0 | V0 |
| Tensile Modulus (MPa) | | 7200 ± 100 | 6000 ± 100 | 7700 ± 100 | 5800 ± 50 |
| Tensile Strength (MPa) | | 133 ± 2 | 94 ± 2 | 188 ± 1 | 90 ± 0.2 |
| Elongation at break (%) | | 2.9 ± 0.1 | 3.2 ± 0.2 | 2.8 ± 0.1 | 3.9 ± 0.1 |
| Izod Unnotched (kJ/m²) | | 41.5 | 39.8 | 42 | 43 |

As shown above, Comparative Example A, which contains 21% of the flame retardant, does not meet the flame retardant (UL94 V1) and glow wire (GWIT) requirements. Increasing the flame retardant amount to 24%, as in Comparative Examples B and C, results in sufficient flame retardancy (UL94 V0) at 0.8 mm. However, GWIT performance was not improved in these examples.

Ex. 1 and Ex. 2, however, both of which include an FR synergist, meet flame retardant and glow wire requirements. Surprisingly, Ex. 2, which further comprises an impact modifier, shows significant improvements in ductility and softness without any detrimental effect on UL94 and glow wire performance.

### Examples 3-4: Amount of Impact Modifier

To further determine the effect of the presence of an impact modifier on flame retardancy and glow wire ignition, four formulations (Exs. 3 and 4 and Comp. Exs. D and E) were prepared using varying amounts of Lotader AX8900 as the impact modifier, as shown below in Table 3. Each formulation included at least some of the additives mentioned above.

TABLE 3

| Component (wt %) | Ex. 3 | Ex. 4 | Comp. Ex. D | Comp. Ex. E |
|---|---|---|---|---|
| PA66 | balance | balance | balance | balance |
| PA6 | 10 | 10 | 10 | 10 |
| Glass fibers | 10 | 10 | 10 | 10 |
| FR (phosphinate) | 21 | 21 | 21 | 21 |
| FR synergist | 5 | 5 | 5 | 5 |
| Impact modifier | 5 | 7.5 | 10 | 12.5 |

The formulations were formed into coupons and tested for the performance properties as discussed above. The results are shown below in Table 4.

TABLE 4

| Test | Ex. 3 | Ex. 4 | Comp. Ex. D | Comp. Ex. E |
|---|---|---|---|---|
| GWFI 960° C.; @1.6 mm | Pass | Pass | Pass | Fail |
| GWIT 775° C.; @1.6 mm | Pass | Pass | Pass | Pass |
| UL94 @0.8 mm | V0 | V0 | Fail | Fail |
| UL94 @1.6 mm | V0 | V0 | V0 | V0 |
| Tensile Modulus (MPa) | 4500 ± 100 | 5300 ± 100 | 4000 ± 100 | 4800 ± 100 |
| Tensile Strength (Mpa) | 71 ± 1 | 79 ± 4 | 65 ± 1 | 76 ± 1 |
| Elongation at break (%) | 3.9 ± 0.2 | 3.6 ± 0.1 | 4.3 ± 0.2 | 4.1 ± 0.1 |
| Izod Unnotched (kJ/m²) | 33 | 42 | 36 | 52 |

As shown above, while all samples meet GWIT requirements, those samples that comprise less than 10 wt % impact modifier demonstrated superior UL94 flame retardancy performance, while those samples with 10+wt % demonstrated poor UL94 flame retardancy.

### Examples 5-6: Phosphinate Flame Retardant

Exs. 5 and 6 were prepared using different phosphinate flame retardants (Flame Retardant A was Exolit 1312 and Flame Retardant B was Exolit 1380).

The components of the two formulations are shown below in Table 5.

TABLE 5

| Component (wt %) | Ex. 5 | Ex. 6 |
|---|---|---|
| PA66 | 48.25 | 48.25 |
| PA6 | 10 | 10 |
| Glass fibers | 10 | 10 |
| FR A (phosphinate) | 21 | — |
| FR B (phosphinate) | — | 21 |
| FR synergist | 5 | 5 |
| Impact modifier | 5 | 5 |
| Aluminum stearate | 0.25 | 0.25 |
| Antiox. (Irganox 1098) | 0.25 | 0.25 |
| Antiox. (Irgafos 168) | 0.25 | 0.25 |

Exs. 5 and 6 were formed into coupons and tested for mechanical, thermal, and combustibility characteristics. The results are shown below in Table 6.

TABLE 6

| Property | Test Method | Units | Ex. 5 | Ex. 6 |
|---|---|---|---|---|
| GWFI 960° C. @1.6 mm | IEC 60695-2-12 | sec | 5 | 5 |
| GWIT @1.6 mm | IEC 60695-2-13 | ° C. | PASS 775 | PASS 775 |
| UL 94 @3.2 mm | UL 94 | Rating | V0 | V0 |
| UL 94 @1.6 mm | UL 94 | Rating | V0 | V0 |
| UL 94@0.8 mm | UL 94 | Rating | V0 | V0 |
| Tensile Modulus 1 mm/mn | 527 | MPa | 5170 ± 40 | 5100 ± 70 |
| Tensile Strength | 527 | MPa | 84 ± 1 | 84 ± 1 |
| Elongation at break 5 mm/mn | 527 | % | 3.3 ± 0.1 | 3.5 ± 0.1 |
| Flexural Stress 2 mm/mn | 178 | MPa | 134 ± 3 | 134 ± 2 |
| Flexural Modulus 2 mm/mn | 178 | MPa | 4770 ± 50 | 4650 ± 70 |
| Izod Notched, +23° C. −1eA | 180 | kJ/m² | 5.3 ± 0.2 | 5.6 ± 0.2 |
| Izod unnotched, +23° C. −1eU | 180 | kJ/m² | 34 ± 2 | 35 ± 2 |
| Charpy notched, +23° C. −1eA | 179 | kJ/m² | 5.3 ± 0.4 | 5.7 ± 0.4 |
| Charpy unnotched, +23° C. −1eU | 179 | kJ/m² | 40 ± 3 | 44 ± 2 |
| HDT/1.82 MPa -Span 64 mm | 75 | ° C. | 213 ± 6 | 208 ± 7 |
| Melting point by DSC | 3146 | ° C. | 175 & 262 | 174 & 255 |

As can be seen in Table 6, Exs. 5 and 6 perform similarly in all tests, displaying desirable mechanical, thermal, and combustibility characteristics.

### Comparative Examples F-H: Phosphinic Acid-Based Flame Retardant

A similar set of samples were prepared using a phosphorus acid-based flame retardant in place of the phosphinate flame retardant. The compositions of the formulations are shown below in Table 7.

TABLE 7

| Component (wt %) | Comp. Ex. F | Comp. Ex. G | Comp. Ex. H |
|---|---|---|---|
| Polymer | PA66 | PA66 | PA66 |
| Glass fibers | 10 | 10 | 10 |
| FR (Phosphinic acid) | 21 | 21 | 21 |
| FR synergist | 5 | 5 | 5 |
| Impact modifier | 0 | 5 | 10 |

Testing showed that Comp. Exs. F, G, and H each failed to meet both the flame retardancy and glow wire requirements, as shown below in Table 8.

TABLE 8

| | Comp. | Comp. | Comp. |
|---|---|---|---|
| Test | Ex. F | Ex. G | Ex. H |
| GWFI 960° C.; @1.6 mm | Pass | Pass | Pas |
| GWIT 775° C.; @1.6 mm | Fail | Pass | Pass |
| UL94 @0.8 mm | Pass | Fail | Fail |
| UL94 @1.6 mm | V0 | V0 | V2 |
| Tensile Modulus (MPa) | 6200 ± 100 | 5100 ± 100 | 4300 ± 100 |
| Tensile Strength (MPa) | 87 ± 1 | 80 ± 2 | 70 ± 2 |
| Elongation at break (%) | 2.7 ± 0.5 | 3.7 ± 0.2 | 4.7 ± 0.1 |
| Izod Unnotched (kJ/m²) | 24 | 37 | 44 |

### Example 7: GWEPT Performance

To meet the requirements of IEC 60335, all components that carry a current of >0.2A and are intended for use in unattended household appliances must be able to withstand the criteria of IEC 60695-2-11. As described above, the test is conducted by applying a glow wire at a temperature of 750° C. to the test specimen for 30 seconds. A maximum combined flame duration of <2 seconds is allowed.

To test GWEPT performance, a Flat Blade 24-circuit housing was molded from the composition shown below in Table 9. The flame retardant was a non-halogenated organic phosphinate, and the FR synergist was a melamine polyphosphate.

TABLE 9
Ex. 7

| Component | wt % |
|---|---|
| PA66 | 48.35 |
| PA6 | 10 |
| Glass fibers | 10 |
| FR (phosphinate) | 21 |
| FR synergist | 5 |
| Impact modifier | 5 |
| Aluminum stearate | 0.25 |
| Antiox. (Irganox 1098) | 0.15 |
| Antiox. (Irgafos 168) | 0.25 |

In order to fully characterize GWEPT robustness, GWEPT test was performed separately along the x, y, and z axes of the molded part. Five rounds of testing were performed. The results are shown below in Table 10, in which Tᵢ indicates the time of ignition; Tₑ indicates the time until the flame is extinguished, measuring from the start of the test; Ta indicates the time of application of the glow wire; Height indicates the height of the flame; Drops indicates whether dropping of the burnt portion occurs (rated as yes or no); Burn indicates whether light tissue paper burns (rated as yes or no); and P/F indicates the final rating of Pass or Fail.

TABLE 10

| Temp. | | Tᵢ | Tₑ | Tₐ | | Drops | Burn | Overall |
|---|---|---|---|---|---|---|---|---|
| ° C. | Axis | (sec) | (sec) | (sec) | Height | (Y/N) | (Y/N) | P/F |
| 750 | X | 0 | 0 | 30 | 0 | N | N | P |
| 750 | X | 0 | 0 | 30 | 0 | N | N | P |
| 750 | X | 0 | 0 | 30 | 0 | N | N | P |
| 750 | X | 0 | 0 | 30 | 0 | N | N | P |
| 750 | X | 0 | 0 | 30 | 0 | N | N | P |
| 750 | Y | 0 | 0 | 30 | 0 | N | N | P |
| 750 | Y | 0 | 0 | 30 | 0 | N | N | P |
| 750 | Y | 0 | 0 | 30 | 0 | N | N | P |
| 750 | Y | 0 | 0 | 30 | 0 | N | N | P |
| 750 | Y | 0 | 0 | 30 | 0 | N | N | P |
| 750 | Z | 0 | 0 | 30 | 0 | N | N | P |
| 750 | Z | 0 | 0 | 30 | 0 | N | N | P |
| 750 | Z | 0 | 0 | 30 | 0 | N | N | P |
| 750 | Z | 0 | 0 | 30 | 0 | N | N | P |
| 750 | Z | 0 | 0 | 30 | 0 | N | N | P |

As shown above, Flat Blade 24-circuit housings molded from the compositions described herein meet the requirements of IEC 60335 for unattended household appliances carrying greater than 0.2A.

### EMBODIMENTS

As used below, any reference to a series of embodiments is to be understood as a reference to each of those embodiments disjunctively (e.g., “Embodiments 1-4” is to be understood as “Embodiments 1, 2, 3, or 4”).

Embodiment 1: A flame retardant polyamide composition comprising a polyamide; less than 24 wt % of a non-halogenated, phosphinate-based flame retardant; at least one of: an impact modifier comprising an alkene/acrylate copolymer/terpolymer, present in an amount less than 10 wt %; and a flame retardant synergist and optional reinforcing agent; wherein the flame retardant polyamide composition demonstrates a passing value for a glow wire end product test as measured by IEC 60695-2-11, a passing value for a glow wire ignition test as measured by IEC-60695-2-13:201; a passing value (V0 rating) for UL94 performance at 0.8 mm; and an elongation at break greater than 2.7%, as measured by to ISO Test No. 527:2012.

Embodiment 2: The flame retardant polyamide composition of Embodiment 1, wherein the impact modifier comprises a random terpolymer comprised of units of ethylene, methyl acrylate, and glycidyl methacrylate.

Embodiment 3: The flame retardant polyamide composition of Embodiment 1 or Embodiment 2, comprising from 1 wt % to 10 wt % of the impact modifier, based on the total weight of the flame retardant polyamide composition.

Embodiment 4: The flame retardant polyamide composition of Embodiment 3, comprising from 3 wt % to 9 wt % of the impact modifier, based on the total weight of the flame retardant polyamide composition.

Embodiment 5: The flame retardant polyamide composition of Embodiments 1-4, comprising from 0.01 wt % to 24 wt % of the non-halogenated, phosphinate-based flame retardant, based on the total weight of the flame retardant polyamide composition.

Embodiment 6: The flame retardant polyamide composition of Embodiment 5, comprising from 5 wt % to 21 wt % of the non-halogenated, phosphinate-based flame retardant, based on the total weight of the flame retardant polyamide composition.

Embodiment 7: The flame retardant polyamide composition of Embodiments 1-6, wherein the non-halogenated flame retardant comprises a diethylphosphinate aluminum salt (DEPAL)-based flame retardant.

Embodiment 8: The flame retardant polyamide composition of Embodiments 1-7, wherein the flame retardant synergist is a melamine-based synergist.

Embodiment 9: The flame retardant composition of Embodiment 8, wherein the flame retardant synergist is melamine polyphosphate.

Embodiment 10: The flame retardant polyamide composition of Embodiments 1-9, comprising the flame retardant synergist optionally in an amount ranging from 0.1 wt % to 5 wt %.

Embodiment 11: The flame retardant polyamide composition of Embodiments 1-10, further comprising an additive, wherein the additive comprises stabilizers, colorants, lubricants, antioxidants, or light stabilizers or combinations thereof.

Embodiment 12: The flame retardant polyamide composition of Embodiments 1-11, comprising less than 50 wt % reinforcing agent, wherein the reinforcing agent is reinforced glass fibers having an average diameter greater than 7 microns.

Embodiment 13: The flame retardant polyamide composition of Embodiments 1-12, comprising from 5 wt % to 85 wt % polyamide, comprising PA-6, PA-66, PA-6,6/6I, PA-6I/6 T, PA-6,6/6T, long chain polymers such as PA12, PA610, PA612, or mixtures thereof, based on the total weight of the flame retardant polyamide composition.

Embodiment 14: The flame retardant polyamide composition of Embodiments 1-13, wherein the polyamide comprises PA-66 and PA-6.

Embodiment 15: The flame retardant polyamide composition of Embodiments 1-14, wherein the flame retardant polyamide composition demonstrates a tensile modulus greater than 3500 MPa and/or a tensile strength of greater than 60 MPa.

Embodiment 16: A flame retardant polyamide composition comprising: a polyamide; from 5 wt % to 21 wt % of a non-halogenated diethylphosphinate aluminum salt (DEPAL)-based flame retardant; from 0.1 wt % to 7.5 wt % of an impact modifier comprising an alkene/acrylate copolymer/terpolymer; a flame retardant synergist comprising melamine polyphosphate and an optional reinforcing agent; wherein the flame retardant polyamide composition demonstrates a passing value for a glow wire end product test as measured by IEC 60695-2-11, a passing value for a glow wire ignition test as measured by IEC-60695-2-13:201; a passing value (V0 rating) for UL94 performance at 0.8 mm; and an elongation at break greater than 2.7%, as measured by to ISO Test No. 527:2012.

Embodiment 17: The flame retardant polyamide composition of Embodiment 16, wherein the flame retardant polyamide composition demonstrates a tensile modulus greater than 3500 MPa and/or a tensile strength of greater than 60 MPa.

Embodiment 18: A molded product comprising the flame retardant polyamide composition of Embodiments 1-17.

Embodiment 19: The flame retardant molded product of Embodiment 18, wherein the flame retardant molded product is an electrical connector.

Embodiment 20: The flame retardant molded product of Embodiment 19, wherein the flame retardant molded product demonstrates a passing value for a glow wire end product test as measured by IEC 60695-2-11.

Embodiment 21: an embodiment Embodiments 1-17 wherein the flame retardant polyamide composition demonstrates a comparative tracking index greater than 250 volts as measured by IEC 60112:2003, e.g., greater than 300 volts, greater than 350 volts, greater than 400 volts, greater than 500 volts, or greater than 600 volts.

We claim:

1. A flame retardant polyamide composition comprising:
a polyamide;
less than 24 wt % of a non-halogenated, phosphinate-based flame retardant;
at least one of:
an impact modifier comprising an alkene/acrylate copolymer/terpolymer, present in an amount less than 10 wt %; and
a flame retardant synergist and
optional reinforcing agent;
wherein the flame retardant polyamide composition demonstrates a passing value for a glow wire end product test as measured by IEC 60695-2-11, a passing value for a glow wire ignition test as measured by IEC-60695-2-13:201; a passing value (V0 rating) for UL94 performance at 0.8 mm; and an elongation at break greater than 2.7%, as measured by to ISO Test No. 527:2012.

2. The flame retardant polyamide composition of claim 1, wherein the impact modifier comprises a random terpolymer comprised of units of ethylene, methyl acrylate, and glycidyl methacrylate.

3. The flame retardant polyamide composition of claim 1, comprising from 1 wt % to 10 wt % of the impact modifier, based on the total weight of the flame retardant polyamide composition.

4. The flame retardant polyamide composition of claim 3, comprising from 3 wt % to 9 wt % of the impact modifier, based on the total weight of the flame retardant polyamide composition.

5. The flame retardant polyamide composition of claim 1, comprising from 0.01 wt % to 24 wt % of the non-halogenated, phosphinate-based flame retardant, based on the total weight of the flame retardant polyamide composition.

6. The flame retardant polyamide composition of claim 5, comprising from 5 wt % to 21 wt % of the non-halogenated, phosphinate-based flame retardant, based on the total weight of the flame retardant polyamide composition

7. The flame retardant polyamide composition of claim 1, wherein the non-halogenated flame retardant comprises a diethylphosphinate aluminum salt (DEPAL)-based flame retardant.

8. The flame retardant polyamide composition of claim 1, wherein the flame retardant synergist is a melamine-based synergist.

9. The flame retardant composition of claim 8, wherein the flame retardant synergist is melamine polyphosphate.

10. The flame retardant polyamide composition of claim 1, comprising the flame retardant synergist optionally in an amount ranging from 0.1 wt % to 5 wt %.

11. The flame retardant polyamide composition of claim 1, further comprising an additive, wherein the additive comprises stabilizers, colorants, lubricants, antioxidants, or light stabilizers or combinations thereof.

12. The flame retardant polyamide composition of claim 1, comprising less than 50 wt % reinforcing agent, wherein the reinforcing agent is reinforced glass fibers having an average diameter greater than 7 microns.

13. The flame retardant polyamide composition of claim 1, comprising from 5 wt % to 85 wt % polyamide, comprising PA-6, PA-66, PA-6,6/6I, PA-6I/6 T, PA-6,6/6T, long chain polymers such as PA12, PA610, PA612, or mixtures thereof, based on the total weight of the flame retardant polyamide composition.

14. The flame retardant polyamide composition of claim 1, wherein the polyamide comprises PA-66 and PA-6.

15. The flame retardant polyamide composition of claim 1, wherein the flame retardant polyamide composition demonstrates a tensile modulus greater than 3500 MPa and/or a tensile strength of greater than 60 MPa.

16. A flame retardant polyamide composition comprising:
a polyamide;
from 5 wt % to 21 wt % of a non-halogenated diethylphosphinate aluminum salt (DEPAL)-based flame retardant;
from 0.1 wt % to 7.5 wt % of an impact modifier comprising an alkene/acrylate copolymer/terpolymer;
a flame retardant synergist comprising melamine polyphosphate and
an optional reinforcing agent;
wherein the flame retardant polyamide composition demonstrates a passing value for a glow wire end product test as measured by IEC 60695-2-11, a passing value for a glow wire ignition test as measured by IEC-60695-2-13:201; a passing value (V0 rating) for UL94 performance at 0.8 mm; and an elongation at break greater than 2.7%, as measured by to ISO Test No. 527:2012.

17. The flame retardant polyamide composition of claim 16, wherein the flame retardant polyamide composition demonstrates a tensile modulus greater than 3500 MPa and/or a tensile strength of greater than 60 MPa.

18. A molded product comprising the flame retardant polyamide composition of claim 1.

19. The flame retardant molded product of claim 18, wherein the flame retardant molded product is an electrical connector.

20. The flame retardant molded product of claim 19, wherein the flame retardant molded product demonstrates a passing value for a glow wire end product test as measured by IEC 60695-2-11.
